(19) United States
(12) Patent Application Publication
(10) Pub. No.: US 2024/0326613 A1
(43) Pub. Date: Oct. 3, 2024

(54) ELECTRIC VEHICLE POWER SYSTEM AND ELECTRIC VEHICLE USING THE SAME

(71) Applicant: HON HAI PRECISION INDUSTRY CO., LTD., New Taipei (TW)

(72) Inventors: MING-YAO CHENG, New Taipei (TW); CHIH-KAI KUNG, New Taipei (TW); MING-SHIUAN LU, New Taipei (TW)

(21) Appl. No.: 18/611,135

(22) Filed: Mar. 20, 2024

(30) Foreign Application Priority Data
Mar. 27, 2023 (CN) 202310307609.2

(51) Int. Cl. B60L 50/64; B60L 50/60; B60L 58/20; B60R 16/033

(52) U.S. Cl. CPC B60L 50/64; B60L 58/20; B60R 16/033; B60L 50/66; B60L 2210/10; B60L 2210/42

(57) ABSTRACT

An electric vehicle power system, comprises: an electric motor, configured to provide power to an electric vehicle; a main converter coupled with the electric motor, and being a DC-to-AC converter or a DC-to-DC converter; a main battery pack electrically connected to the main converter through a first DC-DC converter; and a fixed battery electrically connected to the main converter through a second DC-DC converter.

### CROSS-REFERENCE TO RELATED APPLICATIONS

This application claims all benefits under 35 U.S.C. § 119 from the Chinese Patent Application No. 202310307609.2, filed on Mar. 27, 2023, in the China National Intellectual Property Administration, the disclosure of which is incorporated herein by reference.

### FIELD

The disclosure belongs to field of electric vehicles, and in particular an electric vehicle power system and an electric vehicle using the power system.

### BACKGROUND

The growing awareness of the concept of environmental protection and energy conservation, in a technical field of transportation vehicles, electric vehicles that reduce energy consumption and reduce pollution and waste emissions have become the main products of various car manufacturers and are becoming more and more popular among consumers.

However, the biggest technical challenge faced by electric vehicles is to increase the energy density of the battery and shorten the charging time of the battery. In order to power an electric vehicle's motor with the energy it needs, the battery itself must have the ability to deliver instantaneous high-power output. Therefore, batteries for electric vehicles must have high energy density, fast charging capabilities, and high-power discharge characteristics, which are huge challenges for electric vehicles.

When the battery power is exhausted, the electric vehicle must park at a place with a charging device (such as home or a charging station) to recharge the battery. Take the current commercially available electric vehicles that can travel about 150 km with a fully charged battery as an example, currently, it takes at least about 1.5 hours to fully charge the battery, even using fast charging technology to charge the battery to 80% still takes about 20˜30 minutes. Because the replenishment of electric energy is not convenient enough, the popularization of electric vehicles still requires considerable efforts in batteries.

Therefore, how to extend the driving range of batteries for electric vehicles and make them easy to replenish energy is one of the current important issues, and it is still a goal that the industry strives to achieve.

### BRIEF DESCRIPTION OF THE DRAWINGS

In order to illustrate the technical solutions of the embodiments of the present application more clearly, the accompanying drawings in the embodiments will be briefly introduced below. It should be understood that the following drawings only show some embodiments of the present application, and therefore should not be seen as limiting the scope. For one of ordinary skill in the art, other related drawings can also be obtained from these drawings without any creative work.

FIG. 1 is a schematic diagram of an electric vehicle power system provided by one embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to be considered as limiting the scope of the embodiments described herein.

The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series, and the like. It should be noted that references to “an” or “one” embodiment in this disclosure are not necessarily to the same embodiment, and such references mean at least one.

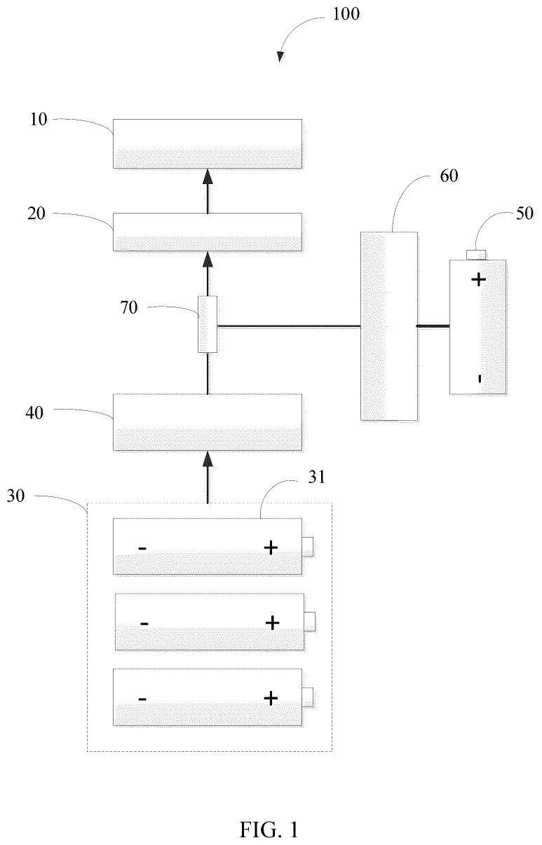

Referring to FIG. 1, one embodiment of the present disclosure provides an electric vehicle power system 100. This electric vehicle power system 100 comprises an electric motor 10, a main converter 20, a main battery pack 30, a first DC-DC converter 40, a fixed battery 50, a second DC-DC converter 60 and a busbar 70. The electric motor 10 is configured to provide power to an electric vehicle. The main converter 20 is coupled with the electric motor 10. The busbar 70 is couple with the main converter 20. The main battery pack 30 is configured to provide electric energy to the motor 10. The main battery pack 30 is electrically connected to the main converter 20 through the first DC-DC converter 40 and the busbar 70. The fixed battery 50 is configured to selectively provide power to the electric motor. The fixed battery 50 is electrically connected to the main converter 20 through the second DC converter 60 and the busbar 70. The second DC-DC converter 60 is electrically connected to the main converter 20 via the busbar 70. A type of the main converter 20 is determined according to a type of the motor 10. If the motor 10 is AC, the main converter 20 is a converter converting DC to AC. If the motor 10 is DC, and the main converter 20 is a DC-to-DC converter.

The main battery pack 30 can be replaced or recharged. The main battery pack 30 comprises a shell (not labeled) and at least two electrically connected batteries 31. According to the powertrain design, only one battery 31 can be used at a time, so when the one battery 31 is low, it can be switched to another battery 31 in the main battery pack 30 to provide power for the motor and other power-demanding components in the electric vehicle. The at least two batteries are located within the shell. The number of batteries in the main battery pack 30 can be designed according to actual needs. In this embodiment, as shown in FIG. 1, the main battery pack 30 comprises three batteries 31. The main battery pack 30 is configured to provide power to the entire electric vehicle, including various components that require power, such as energy for driving the electric motor, vehicle lights, and lifting and lowering of window glass. The main battery pack 30 can be charged. When the power of the main battery pack 30 is insufficient, the main battery pack 30 can be replaced by the same type batteries. In other embodiment, when the power of the main battery pack 30 is insufficient, only the one low-power battery 31 can be replaced while using another battery 31 to continue working. After the replaced main battery pack 30 or low-power battery 31 is fully charged, it can be put into use for the next round. Of course, a use object is Electric vehicles with this standard battery specification.

The first DC-DC converter 40 is configured to convert the DC power provided by the main battery pack 30 into DC power with a required voltage of the busbar 70.

The fixed battery 50 is fixed inside the electric vehicle and is spaced apart from the main battery pack 30. The fixed battery 50 is an auxiliary power source of the electric vehicle, and does not work along without the main battery pack 30. When the electric vehicle is generally driven, the fixed battery 50 does not work when the discharge power performance of the main battery pack 30 is sufficient to meet the driving requirements. When the load of the electric vehicle is large, or the discharge power performance of the main battery pack 30 is not sufficient to meet the driving needs, such as when climbing a hill, loading a heavy load, or accelerating quickly, the main battery pack 30 and the fixed battery 50 can work at the same time to provide energy to the electric vehicle. In addition, when the main battery pack 30 has sufficient power, the fixed battery 50 has low power and needs to be charged, the main battery pack 30 can charge the fixed battery 50. The fixed battery 50 can also be charged by external power sources and charging equipment. When the electric vehicle is charged at a charging pile, the main battery pack 30 and the fixed battery 50 can be charged at the same time. When the electric vehicle goes downhill, the electric motor of the electric vehicle can also charge the stationary battery 50 in reverse.

An output power of the fixed battery 50 is greater than that of the main battery pack 30. Therefore, the fixed battery 50 can cope with the demand for providing instantaneous high-power loads. When the load of the electric vehicle is too large, the main battery pack 30 and the fixed battery 50 together provide power for driving the electric vehicle. When the load of the electric vehicle is small, only the main battery pack 30 provides power. A critical point of the electric vehicle load is determined by the main battery pack 30 of the electric vehicle, that is, when only the main battery pack 30 is used for power supply, and when the main battery pack 30 and the fixed battery 50 are required to work together, is determined by the main battery pack 30. Generally speaking, only after the maximum discharge power of the main battery pack 30 is exceeded, the fixed battery 50 participates in the discharge. Of course, if there are other considerations, for example, before reaching the maximum discharge power of the main battery pack 30, the fixed battery 50 will participate in the discharge. Under the condition that the fixed battery 50 has no impact or the impact is negligible, such a setting can improve the performance of the main battery pack' 30 service life. This setting can be achieved by setting the electric vehicle when it leaves the factory, or setting it when the electric vehicle is subsequently used. This function can even be further provided to the driver for adjustment through the UI (user interface) on the vehicle. When the main battery pack 30 runs out of power, it must be replaced or charged. At this time, the electric vehicle can be drive to a nearby power supply station to replace or charge the main battery pack.

The fixed battery 50 has a smaller electrical capacity than the main battery pack 30. The stationary battery 50 has a lower energy density than the main battery pack 30. The fixed battery 50 can maintain a smaller volume and lighter weight without affecting the overall design of the electric vehicle.

The second DC-DC converter 60 is configured to convert the DC power provided by the fixed battery 50 into DC power of different voltages required by the busbar 70.

The busbar 70 provide DC power to the main converter 20. According to the type of the motor 10, the main converter 20 is determined to be a DC-to-AC converter or a DC-to-DC converter. In one embodiment, the main converter 20 is a DC-to-AC converter, which is configured to convert the DC power provided by the busbar 70 into an AC power and provide it to the motor. In another embodiment, the main converter 20 is a DC-to-DC converter, which is configured to convert the DC power provided by the busbar 70 into a DC power with different voltage and provide it to the motor.

The main converter 20 and the electric motor 10 together form a driving unit of the electric vehicle power system 100.

The electric vehicle power system provided by the present disclosure has the following advantages: first, the fixed battery serves as an auxiliary battery and works in conjunction with the main battery pack, which can greatly improve the acceleration performance of the electric vehicle. Second, the fixed battery works when the electric vehicle load is large, ensuring the normal operation of the electric vehicle under extreme conditions, and allowing the electric vehicle manufacturer to take the lead in the performance design of electric vehicles, and will not be dominated by the standard battery replacement system. Third, the main battery pack can be replaced. Replacing the battery takes much less time than charging the battery directly, making the use of electric vehicles more convenient. Fourth, the main battery pack and the stationary battery are respectively connected to a DC converter, therefore, no matter whether there is a difference in voltage between the main battery pack and the stationary battery, the voltage can be adjusted by their respective DC converters and converted into the voltage required by the electric vehicle power system 100.

The present disclosure further provides an electric vehicle, which adopts the above-mentioned electric vehicle power system 100. A model of the electric vehicle is not limited, and can be an electric vehicle, an electric truck, an electric bicycle, etc. In this embodiment, the electric vehicle is an electric car. The main battery pack 30 can be located in any open space of the body of the electric vehicle, or a semi-enclosed space or a closed space specifically designed for exchanging battery compartments. In this embodiment, the main battery pack 30 is in a closed space under the trunk of the electric vehicle. The closed space is provided with an opening, which can be opened for replacing the main battery pack 30.

The electric vehicle can further comprise a main battery pack replacement device (not shown). The main battery pack replacement device is configured to unload the main battery pack 30 and replace the main battery pack 30 with a new one. In addition, due to the heavy weight of the main battery pack, which is about 50 kg to 150 kg, part of the manpower can be invested in the replacement operation to replace the fully automated replacement equipment, which can also reduce the cost of fully automated equipment.

The fixed battery 50 can be located in any accommodation space of the electric vehicle and is firmly combined with the body of the electric vehicle. In this embodiment, the fixed battery 50 is located in an accommodation space below the side of the electric vehicle. It can be understood that, the position of the fixed battery 50 can be changed according to the design of the vehicle model. The electric vehicle can further comprise a charging interface, which is electrically connected to the fixed battery 50 and configured to charge the fixed battery 50 with an external power source.

The electric vehicle can be charged by main battery packs of different brands and capacities, and the used main battery pack can also be used for electric vehicles of different brands and models after being charged. Charging stationary batteries through the main battery pack will extend the driving distance and usage time of electric vehicles. As for the power supply station, the power supply station can provide an operating space for electric vehicles to replace the main battery pack, and while replacing the main battery pack, the power supply station can use the DC charging device to perform basic charging of the main battery pack, so that the main battery pack is able to retain a certain level of energy, which can extend the life of the main battery pack.

The electric vehicle power system provided by the present disclosure comprises a combination of a high-power fixed battery and a high-energy-density replaceable main battery pack. The fixed battery is fixed in the vehicle body under normal conditions. The replaceable main battery pack is used under normal conditions. When the energy power is low, the vehicle can drive to a battery swap station. The battery swap station will quickly replace the main battery pack with automatic mechanical equipment or some manual assistance. The main battery pack is removed and replaced with a high-power main battery pack. The so-called battery swap station can provide replaceable main battery packs of standard sizes. The entire battery replacement process can be completed within a few minutes, which can significantly save energy replenishment time. The fixed battery serves as an auxiliary battery. When the main battery pack is insufficient or the electric vehicle requires greater horsepower, it supplies power to the motor together with the main battery pack, which can save the power of the main battery pack and greatly increase the cruising range of the electric vehicle.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

Depending on the embodiment, certain of the steps of methods described may be removed, others may be added, and the sequence of steps may be altered. The description and the claims drawn to a method may comprise some indication in reference to certain steps. However, the indication used is only to be viewed for identification purposes and not as a suggestion for ordering the steps.

What is claimed is:

1. An electric vehicle power system, comprising:
an electric motor, configured to provide power to an electric vehicle;
a main converter coupled with the electric motor, and being a DC-to-AC converter or a DC-to-DC converter;
a busbar coupled with the main converter;
a main battery pack electrically connected to the busbar through a first DC-DC converter; and
a fixed battery electrically connected to the busbar through a second DC-DC converter.

2. The electric vehicle power system of claim 1, wherein main battery pack is configured to continuously provide electric energy to the electric motor.

3. The electric vehicle power system of claim 1, wherein fixed battery is configured to selectively provide electric energy to the electric motor.

4. The electric vehicle power system of claim 1, wherein the main battery pack comprises at least two electrically connected batteries.

5. The electric vehicle power system of claim 4, wherein the main battery pack comprises a shell, the at least two electrically connected batteries are located in the shell.

6. The electric vehicle power system of claim 1, wherein the first DC-DC converter or the second DC-DC converter is configured to convert a DC power provided by the main battery pack into another DC power with a different voltage to provide to the busbar.

7. The electric vehicle power system of claim 6, wherein the main converter is configured to convert a DC power provided by the busbar into another DC power with different voltage.

8. The electric vehicle power system of claim 1, wherein the fixed battery is fixed inside the electric vehicle and spaced apart from the main battery pack.

9. The electric vehicle power system of claim 1, wherein the fixed battery is an auxiliary power supply for the electric vehicle.

10. The electric vehicle power system of claim 1, wherein an output power of the fixed battery is greater than that of the main battery pack.

11. The electric vehicle power system of claim 1, wherein an electrical capacity of the fixed battery is smaller than that of the main battery pack.

12. The electric vehicle power system of claim 1, wherein the main converter is configured to convert a DC power provided by the main battery pack and the fixed battery into AC power and provide it to the electric motor.

13. An electric vehicle, comprising:
an electric vehicle power system, wherein the electric vehicle power system comprises:
an electric motor, configured to provide power to an electric vehicle;
a main converter coupled with the electric motor, and being a DC-to-AC converter or a DC-to-DC converter;
a busbar coupled with the main converter;
a main battery pack electrically connected to the busbar through a first DC-DC converter; and
a fixed battery electrically connected to the busbar through a second DC-DC converter.

14. The electric vehicle of claim 13, further comprising a main battery pack replacement device, wherein the main battery pack replacement device is configured to unload the main battery pack and replace the main battery pack with a new one.

15. The electric vehicle of claim 13, wherein the main battery pack is be located in an open space in the electric vehicle.
